(19) United States
(12) Patent Application Publication
(10) Pub. No.: US 2008/0266083 A1
(43) Pub. Date: Oct. 30, 2008

(54) METHOD AND ALGORITHM FOR DETECTING MOVEMENT OF AN OBJECT

(75) Inventors: Magnus Midholt, Lund (SE); Michal Stala, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/937,678

(22) Filed: Nov. 9, 2007

Related U.S. Application Data
(60) Provisional application No. 60/914,844, filed on Apr. 30, 2007.

(51) Int. Cl. G08B 21/00

(52) U.S. Cl. 340/540

(57) ABSTRACT

A system, method and computer application for electronic device 10 for detecting movement near an electronic device. The electronic device includes movement detection circuitry configured to detect movement of an object near the movement detection circuitry. The movement detection circuitry includes at least one sensor that detects movement and generates at least one output signal corresponding to a position of the object detected. The electronic device further includes a memory for storing one or more predefined state parameters that correspond to one or more predefined movements to be detected by the movement detection circuitry. During processing, the output signals of the sensors are processed by averaging signals received from the one or more sensors to determine vertical movement above the movement detection circuitry and a determination is made as to whether the output signals of the one or more sensors are active or inactive to determine horizontal movement across the movement detection circuitry.

### RELATED APPLICATION DATA

This application claims the benefit of U.S. Provisional Patent Application Ser. No. 60/914,844, filed Apr. 30, 2007, the entire disclosure of which is hereby incorporated by reference.

### TECHNICAL FIELD OF THE INVENTION

The present invention relates to a method and algorithm for use in a contact-less user interface for electronic equipment that is capable of detecting movement of an object and controlling one or more parameters associated with the electronic equipment and/or applications executed by the electronic equipment based at least in part on the detected movement of the object.

### DESCRIPTION OF THE RELATED ART

Electronic equipment, such as, for example, communication devices, mobile phones, personal digital assistants, etc. are typically equipped to communicate over cellular telephone communication networks. Such electronic equipment generally includes one or more user input devices. Common input devices include, for example, a computer mouse, a track ball, a touchpad, etc. The computer mouse is widely popular as a position indicating device. The computer mouse generally requires a surface upon which to roll or otherwise move a position sensor. The computer mouse translates movement of the position sensor across a surface as input to a computer. The growing popularity of laptop or notebook computers has created a significant problem for mouse type technologies that require a rolling surface. Laptop computers are inherently portable and designed for use in small confined areas such as, for example, airplanes, where there is insufficient room for a rolling surface. Adding to the problem is that a mouse usually needs to be moved over long distances for reasonable resolution. Finally, a mouse requires the user to lift a hand from the keyboard to make the cursor movement, thereby disrupting and/or otherwise preventing a user from periodically typing on the computer.

As a result of the proliferation of laptop computers, a trackball was developed. A track ball is similar to a mouse, but does not require a rolling surface. A track ball is generally large in size and does not fit well in a volume-sensitive application such as a laptop computers or other small and/or portable electronic equipment.

A computer touchpad was also developed. A conventional computer touchpad is a pointing device used for inputting coordinate data to computers and computer-controlled devices. A touchpad is typically a bounded plane capable of detecting localized pressure on its surface. A touchpad may be integrated within a computer or be a separate portable unit connected to a computer like a mouse. When a user touches the touchpad with a finger, stylus, or the like, the circuitry associated with the touchpad determines and reports to the attached computer the coordinates or the position of the location touched. Thus, a touchpad may be used like a mouse as a position indicator for computer cursor control.

There are drawbacks associated with user interfaces that require physical contact. Such drawbacks include, densely populated user interfaces, difficult manipulation of the user interface due to physical size limitation of electronic equipment, difficult for users to view and/or otherwise manipulate densely populated user interfaces, etc.

### SUMMARY

In view of the aforementioned shortcomings associated with user input devices, there is a need in the art for a contact-less user interface and an associated algorithm in electronic equipment that is capable of detecting and/or sensing user movement of an object near the electronic equipment (e.g., user hand movement, gestures, etc.). Once detected, the user movement may be used to control a wide variety of parameters associated with the electronic equipment and/or other electronic equipment.

One aspect of the invention relates to a method for detecting movement near an electronic device, the method comprising: providing an electronic device having movement detection circuitry for detecting contactless movement of an object near the electronic device, wherein the device includes a memory for storing one or more predefined state parameters that correspond to one or more predefined movements to be detected by the movement detection circuitry; detecting movement of an object near the movement detection circuitry; generating detected state information, wherein the detected state information corresponds at least in part to the detected movement of the object; comparing the one or more predefined state parameters with the detected state information; and generating a signal to control one or more user selectable operations of the electronic device based at least in part on the detected movement of the object.

Another aspect of the invention relates to the movement detection circuitry including a plurality of detectors.

Another aspect of the invention relates to the detectors being infrared sensors.

Another aspect of the invention relates to storing the one or more predefined state parameters in a state vector, wherein the predefined state parameters correspond to an output signal associated with at least one of the plurality of detectors.

Another aspect of the invention relates to the state vector corresponding to one or more desired outputs of each of the plurality of detectors.

Another aspect of the invention relates to iteratively comparing the one or more predefined state parameters to the detected state information to determine if a match exists between the predefined state parameters and the detected state parameters.

Another aspect of the invention relates to the detected state information being processed in a first manner to determine vertical movement above the plurality of detectors and in a second manner to determine horizontal movement across the plurality of detectors.

Another aspect of the invention relates to each of the plurality of sensors are processed as either being active or inactive to determine horizontal movement of the object.

Another aspect of the invention relates to each of the plurality of sensors are averaged to determine vertical movement of the object.

Another aspect of the invention relates to determining an elapsed time associated with detecting the match.

Another aspect of the invention relates to if the elapsed time is below a threshold time value a first signal is generated and if the elapsed time is above the threshold time value a second signal is generated.

Another aspect of the invention relates to the one or more user selectable operations consisting of at least one selected from the group consisting of: altering audio from a speaker; altering audio output from a ringer or altering audio output from an alarm.

Another aspect of the invention relates to an electronic device comprising: movement detection circuitry configured to detect movement of an object near the movement detection circuitry, wherein the movement detection circuitry includes at least one sensor and generates at least one output signal corresponding to a position of the object detected; a memory for storing one or more predefined state parameters that correspond to one or more predefined movements to be detected by the movement detection circuitry; and a processor coupled to the memory and the movement detection circuitry, wherein the processor receives one or more signals from the movement detection circuitry and processes the one or more signals according to a movement detection algorithm to detect the one or more predefined movements to control one more operations of the electronic device.

Another aspect of the invention relates to the at least one sensor is an image sensor.

Another aspect of the invention relates to the at least one sensor is a camera.

Another aspect of the invention relates to the movement detection circuitry includes a plurality of sensors.

Another aspect of the invention relates to the plurality of sensors are infrared sensors.

Another aspect of the invention relates to the one or more predefined state parameters are stored in a state vector, wherein the predefined state parameters correspond to an output signal associated with at least one of the plurality of detectors.

Another aspect of the invention relates to the movement detection algorithm iteratively compares the one or more predefined state parameters to the detected state information to determine if a match exists between the predefined state parameters and the detected state parameters.

Another aspect of the invention relates to the movement detection algorithm processes detected state information in a first manner to determine vertical movement above the plurality of detectors and in a second manner to determine horizontal movement across the plurality of detectors.

Another aspect of the invention relates to the plurality of sensors are processed as either being active or inactive to determine horizontal movement of the object.

Another aspect of the invention relates to the plurality of sensors are averaged to determine vertical movement of the object.

Another aspect of the invention relates to the movement detection algorithm compares the one or more output signals from the movement detection circuitry at a first time period and the at least one output signal from the movement detection circuitry at a second time period to determine the match.

Another aspect of the invention relates to a computer program stored on a machine readable medium in an electronic device, the program being suitable for detecting movement of an object near the electronic device, wherein when the computer program is loaded in memory of the electronic device and executed, causes one or more predefined state parameters to be stored in memory and movement detection circuitry having a plurality of sensors to generate detected state information associated with movement of the object near the movement detection circuitry and comparing the one or more predefined state parameters with the detected state information, wherein, comparing the one or more predefined state parameters iteratively to the detected state information to determine if a match exists between the predefined state parameters and the detected state parameters, wherein the detected state information is processed by averaging signals received from the plurality of sensors to determine vertical movement above the plurality of detectors and by determining if the signals received from the plurality of sensors are active or inactive to determine horizontal movement across the plurality of detectors; and generating a signal to control one or more user selectable operations of the electronic device based at least in part on the detected movement of the object.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” and/or “electronic device” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones and the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1 and 2 are exemplary schematic diagrams illustrating electronic equipment in accordance with aspects of the present invention.

FIGS. 3A and 3B is another schematic diagrams illustrating electronic equipment in accordance with aspects of the present invention.

FIGS. 4-8 are various exemplary schematic diagrams illustrating electronic equipment in accordance with aspects of the present invention.

FIG. 9 is a schematic block diagram of an exemplary electronic equipment in accordance with aspects of the present invention.

FIG. 10 is an exemplary cross-sectional view of sensor detection fields in accordance with aspects of the present invention.

FIG. 11 is an exemplary top-view of sensor detection fields in accordance with aspects of the present invention.

FIG. 12 is an exemplary graphical representation of amplitude output from a user input device versus time for horizontal movement detection in accordance with aspects of the present invention.

FIG. 13 is an exemplary graphical representation of amplitude output from a user input device versus time for vertical movement detection in accordance with aspects of the present invention.

FIG. 14 is an exemplary process for detecting horizontal movement in accordance with aspects of the present invention.

FIG. 15 is an exemplary illustration of the various state vectors when implementing aspects of the exemplary process illustrated in FIG. 14.

FIG. 16 is an exemplary process for detecting vertical movement in accordance with aspects of the present invention.

FIG. 17 is an exemplary illustration of the active state vector when implementing aspects of the exemplary process illustrated in FIG. 16.

FIG. 18 is an exemplary method in accordance with aspects of the present invention.

### DETAILED DESCRIPTION OF EMBODIMENTS

The present invention is directed to electronic equipment 10, sometimes referred to herein as an electronic device, communication device, mobile telephone, portable telephone, etc., having motion detection circuitry that is configured to detect motion and/or movement of an object near the electronic equipment and outputs a signal controlling one or more parameters associated with the electronic equipment and/or applications executed by the electronic equipment based at least in part on the detected movement of the object. The output signal is generally indicative of a location, movement, velocity and/or acceleration of the object in relation the movement detection circuitry and is generated without the object necessarily touching the electronic equipment and/or the movement detection circuitry. The movement detection circuitry may be used by an associated user to control one or more features of the electronic equipment and/or applications being executed on the electronic equipment, including user selectable features.

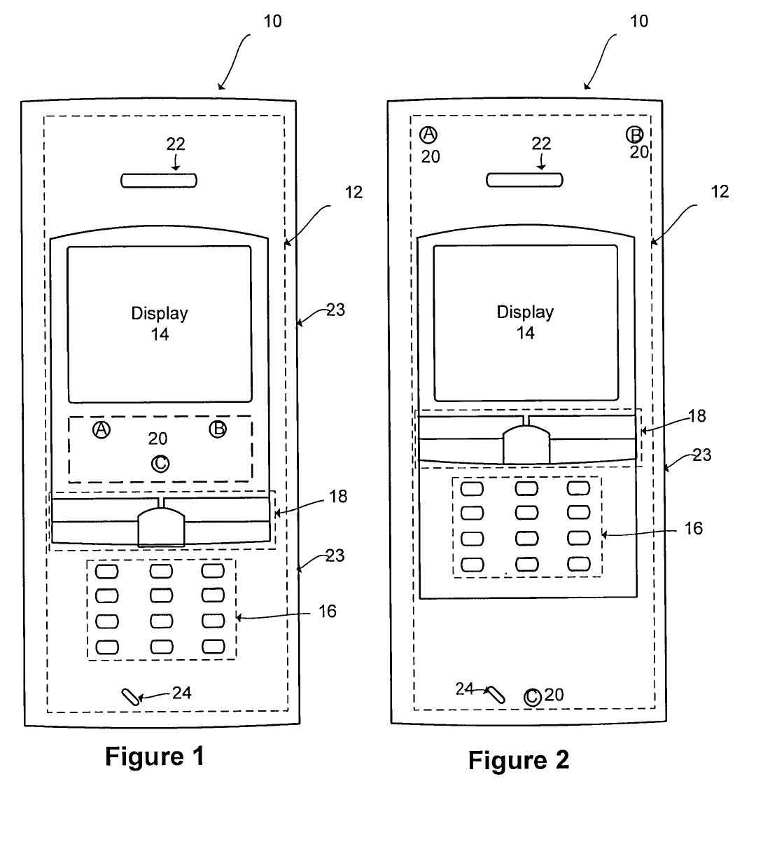

Referring to FIGS. 1 and 2, electronic equipment 10 is shown in accordance with the present invention. The invention is described primarily in the context of a mobile telephone. However, it will be appreciated that the invention is not intended to relate solely to a mobile telephone and can relate to any type of electronic equipment. Other types of electronic equipment that may benefit from aspects of the present invention include personal computers, laptop computers, playback devices, personal digital assistants, alarm clocks, gaming hardware and/or software, etc.

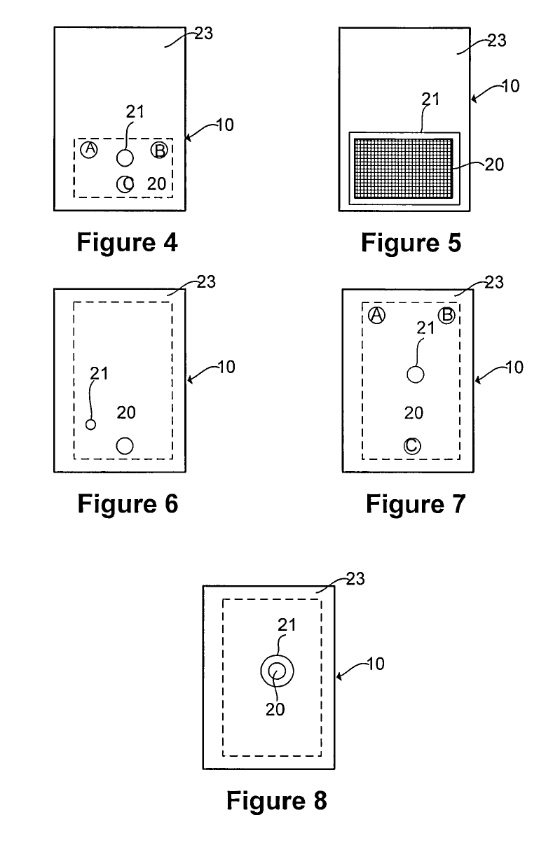

The electronic equipment 10 is shown in FIGS. 1, 2 and 3A-3B as having a “brick” or “block” design type housing, but it will be appreciated that other type housings, such as clamshell housing, as illustrated in FIGS. 4-8, or a slide-type housing may be utilized without departing from the scope of the invention.

As illustrated in FIGS. 1, 2 and 3A-3B, the electronic equipment 10 may include a housing 23 that houses a user interface 12 (identified by dotted lines). The user interface 12 generally enables the user easily and efficiently to perform one or more communication tasks (e.g., identify a contact, select a contact, make a telephone call, receive a telephone call, move a cursor on the display, navigate the display, etc). The user interface 12 (identified by dashed lines) of the electronic equipment 10 generally includes one or more of the following components: a display 14, an alphanumeric keypad 16 (identified by dashed lines), function keys 18, movement detection circuitry 20, one or more light sources 21, a speaker 22, and a microphone 24.

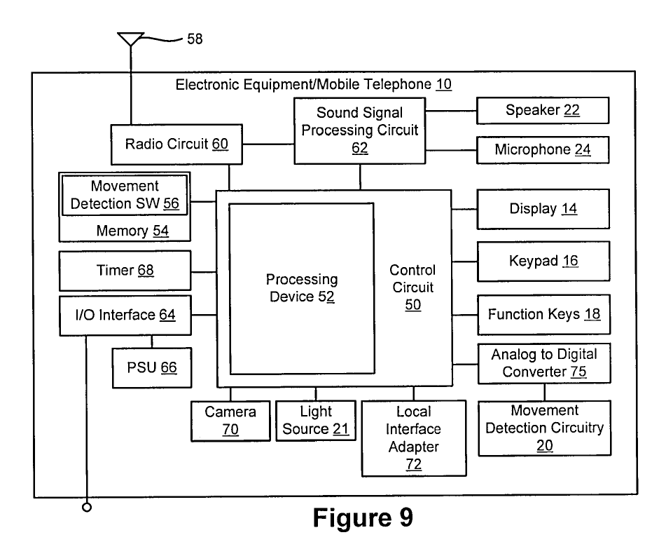

The display 14 presents information to a user such as operating state, time, telephone numbers, contact information, various navigational menus, status of one or more functions, etc., which enable the user to utilize the various features of the electronic equipment 10. The display 14 may also be used to visually display content accessible by the electronic equipment 10. Preferably, the displayed content is displayed in graphical user interface that allows manipulation of objects and/or files by selection of the object and/or file by one or more components of the user interface 12. The displayed content may include graphical icons, bitmap images, graphical images, three-dimensional rendered images, E-mail messages, audio and/or video presentations stored locally in memory 54 (FIG. 9) of the electronic equipment 10 and/or stored remotely from the electronic equipment 10 (e.g., on a remote storage device, a mail server, remote personal computer, etc.). The audio component may be broadcast to the user with a speaker 22 of the electronic equipment 10. Alternatively, the audio component may be broadcast to the user through a headset speaker (not shown).

The electronic equipment 10 further includes a keypad 16 that provides for a variety of user input operations. For example, the keypad 16 may include alphanumeric keys for allowing entry of alphanumeric information such as user-friendly identification of contacts, filenames, E-mail addresses, distribution lists, telephone numbers, phone lists, contact information, notes, etc. In addition, the keypad 16 may include special function keys such as a “call send” key for transmitting an E-mail, initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the electronic equipment 10 may include a volume key, audio mute key, an on/off power key, a web browser launch key, an E-mail application launch key, a camera key, etc. Keys or key-like functionality may also be embodied as a touch screen associated with the display 14.

The movement detection circuitry 20 may be any type of circuitry that is capable of detecting movement of an object without necessarily touching the electronic equipment 10 and/or the movement detection circuitry 20. The movement detection circuitry 20 may be a contact-less sensor, a single sensor, a plurality of sensors and/or an array of sensors. The term movement detection circuitry is intended to be interpreted broadly to include any type of sensor, any number of sensors and/or any arrangement of sensors that is capable of detecting contactless movement of an object over the one or more sensors, unless otherwise claimed. Exemplary sensors include image sensors (e.g., charge-coupled devices (CCD) or complementary metal-oxide-semiconductor (CMOS), infrared sensors (e.g., phototransistors and photodiodes), ultrasonic sensors, electromagnetic sensors, thermal sensors (e.g., heat sensors), location and/or position sensors, etc. In addition, the movement detection circuitry 20 may also be used in combination with a conventional touch sensor (e.g., capacitive touchpad, mouse, touchpad, touch screen, capacitive sensors, etc.).

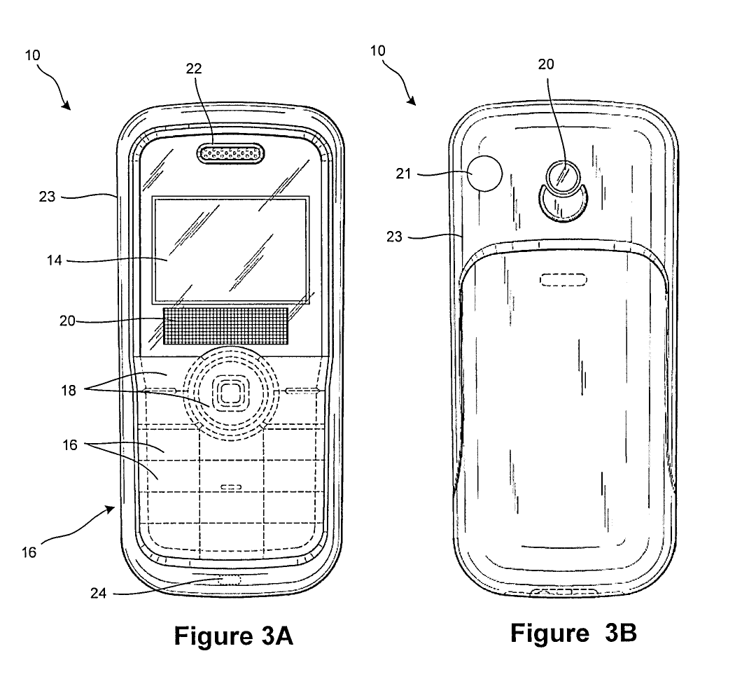

The movement detection circuitry 20 may be located in any desirable position on the electronic equipment 10. The location of the movement detection circuitry 20 may vary based on a number of considerations, including design considerations. Such design considerations include, for example, the type of sensors used, the number of sensors, the size and shape of the electronic equipment, etc. For example, the movement detection circuitry 20 may be located near the center of the electronic equipment, as shown in FIGS. 1 and 3A, near the perimeter of the housing 23 of the electronic equipment, as shown in FIG. 2, or near an end of the housing 23 of the electronic equipment, as shown in FIG. 3B. In addition, the location of the movement detection circuitry 20 may vary due to the type of electronic equipment in which it is incorporated. For example, if the electronic equipment is an alarm clock, the movement detection circuitry 20 may be located on the top of the alarm clock. Likewise, the user input device may be located on multiple surfaces of the electronic equipment for convenience to the user. This is particularly convenient for the user if the electronic equipment may be used in multiple ways and/or orientations. For example, if the electronic equipment is a portable communications device, the movement detection circuitry 20 may be on the front surface and the back surface of the device.

Referring to FIGS. 4 to 8, an electronic equipment 10 is illustrated having a clamshell housing 23. The movement detection circuitry 20 is generally provided on an outer surface of the housing 23. Based on generally the same design considerations discussed above, the movement detection circuitry 20 may be positioned near on end of the housing 23 (FIGS. 4, 5 and 6), positioned on the outer periphery of the housing 23 (FIG. 7), positioned in the center of the housing 23 (FIG. 8) or any combination of locations on the housing 23.

Likewise, the movement detection circuitry 20 may have any desired number and/or configuration of sensors. For example, a plurality of sensors may be positioned in the shape of a triangle as shown in FIGS. 1, 2, 4 and 7, in the form of a matrix as shown in FIGS. 3A and 5, a single sensor as shown in FIGS. 3B, 6 and 8. Other exemplary configurations include a linear orientation, rectangular orientation, square orientation, polygon orientation, circular orientation, etc. As discussed above, one of ordinary skill in the art will appreciate that the number and configuration of sensors may be a design consideration, functional consideration, and/or an aesthetic consideration.

An exemplary movement detection circuitry 20 in the form of a plurality of sensors in the configuration of a triangle is illustrated in FIGS. 1, 2, 4 and 7. As shown, the movement detection circuitry 20 includes a plurality of sensors (e.g., sensors “A”, “B” and “C”). In this embodiment, three sensors are utilized to obtain movement and/or position data in three dimensions. As discussed below, it may be desirable to use more sensors in order to provide higher precision and provide a more robust system. In addition, it may be desirable to use an image sensor (e.g., a camera) that generally includes an image sensor and/or a plurality of densely packed sensors to detect movement of an object near an electronic equipment 10.

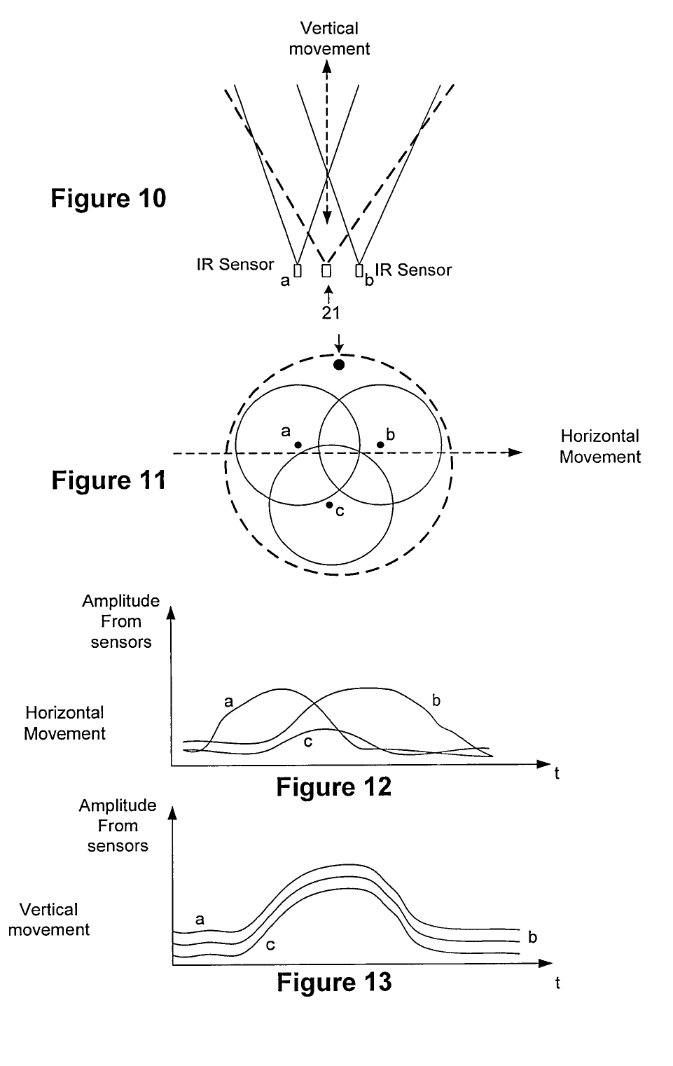

Referring to FIG. 10, a typical cross-sectional side view of an exemplary output field is illustrated for sensors “A” and “B” (the view for sensor “C” has been omitted for clarity). As shown in FIG. 10, an illumination field (identified by the dashed lines) is provided by the light source 21. The illumination field is generally conical in three-dimensions. There are corresponding detection fields associated with the “A” and “B” sensors. The detection fields are also generally conical in three-dimensions. The sensors “A” and “B” are generally configured to detect movement when an object enters the corresponding detection field, as discussed below.

Referring to FIG. 11, a cross-section top view of an exemplary output field is illustrated for sensors “A”, “B” and “C”. Each sensor generally has an overlap region with one or two other sensors and a region where the measured amplitude is predominantly from one sensor. Referring to FIG. 11, as horizontal movement is detected between the “A”, “B” and “C” sensors from left to right in a horizontal direction, as denoted in FIG. 11, an exemplary curve of output amplitudes associated with the signals versus time for each sensor is depicted in FIG. 12. Likewise, vertical movement from the surface of the electronic equipment 10 to beyond the effective target range of the sensors provides an exemplary curve of amplitude versus time for each of the sensors is illustrated in FIG. 13.

One of ordinary skill in the art will readily appreciate that the characteristic output curve will vary depending on the type of sensors used, the configuration of the sensors and the detected movement (e.g., horizontal, vertical, diagonal, circular, etc.). For example, referring to FIG. 11, horizontal movement in closer proximity to sensors “A” and “B” results in a higher detected amplitude for sensors “A” and “B” than for the output amplitude detected for sensor “C”, as shown by FIG. 12. If the horizontal movement was centrally applied to all sensors (e.g., “A”, “B” and “C”), the curve representing sensor “C” would have substantially the same amplitude as sensors “A” and “B” in FIG. 12.

With these principles, aspects of the present invention relate to movement detection circuitry 20 having one or more sensors to determine movement of an object near the electronic equipment 10. For example, detecting movement of an associated user's hand and/or object in the x, y and z directions. When multiple sensors are used in the movement detection circuitry 20, the amplitude output from the respective sensors (e.g., from sensors “A”, “B” and “C”) will generally be proportional to the distance to a reflecting object and the reflectance from the object itself. Thus, relative distance and type of movement (e.g., vertical, horizontal, diagonal, circular, etc.) is possible to detect and quantify. For example, movements up and down, transversal in any direction, rotations clockwise and counter clockwise are possible to detect. Once the movement is detected, a control signal corresponding to the detected movement can then be used for controlling different functions in the electronic equipment (e.g. sound level, start and stop of an application, scrolling in a menu, making a menu selection, modify user selected parameters, etc.).

The sensors that comprise the movement detection circuitry 20 are generally coupled to an analog to digital (A/D) converter 75, as shown in FIG. 9. The A/D converter 75 converts an analog output signal from the corresponding sensor or sensors to a corresponding digital signal or signals for input into the control circuit 50. The converted signals are made available to other components of the electronic equipment 10 (e.g., a movement detection algorithm 56, control circuit 50, memory 54, etc.), for further processing to determine if an object has moved within the range of the sensors and detecting the movement of the object.

In general, a predetermined movement of an object within the effective range of the sensors will generate a corresponding predetermined control signal based upon the algorithm 56 that processes the converted signals. The predetermined control signal may vary based upon one or states of the electronic equipment 10. For example, a detected movement when an application (e.g., an audio and/or video player) is being executed may cause a control signal to be generated that skips to the next track of multimedia content being rendered on the electronic equipment. However, the same user movement detected when another application is being executed may generate a control signal that performs a different function (e.g., turn off an alarm that has been triggered, turn off a ringer, send a call to voice mail, etc.). Likewise, detected object velocity and/or acceleration may also generate control signals that perform different functions. For example, a slow left to right horizontal movement may trigger a fast forward action, while a faster left to right horizontal movement may trigger a skip to next track function.

The target field associated with each of the sensors of movement detection circuitry 20 is identified by a dashed line emanating from the origin of each sensor in FIGS. 10 and 11. The target field for each sensor is generally in the shape of a cone extending outward from the surface of the sensor. Preferably, the effective range of the sensor is approximately 40 centimeters from the surface of the sensor. The effective range (or distance from the sensor) will vary depending on the precise application of the sensor. For example, a smaller electronic device will generally require a smaller effective distance to operate the device. While a larger device may require a larger effective distance to operate on or more features of the device. One of ordinary skill in the art will readily appreciate that the effective range of a sensor may vary based on a number of parameters, such as for example, sensor type, normal operating range of the sensor, sensor application, power supplied to the sensor, parameter being detected, etc.

As shown in FIGS. 3B and 4-8, the housing 23 may include a light source 21 for illuminating an area substantially overlapping the effective range of the sensors. The light source may be any desired light source. An exemplary light source 21 may be a conventional light emitting diode, an infrared light emitting diode or a camera flash. Preferably, the light source 21 has an effective operating range that substantially includes the operating range of the sensors.

In one aspect of the invention, the object (e.g., a user's hand, a pointer, etc.) may be enlightened with light from the light source 21. The light source 21 is preferably modulated with a high frequency (for example 32 kHz) to be able to suppress DC and low frequency disturbances (e.g., the sun and 100 Hz from lamps). The reflected modulated radiation (e.g., infrared light) is detected by use input device sensors (e.g., sensors “A”, “B”, and “C”). As stated above, the infrared sensor can be a phototransistor or a photodiode. The sensors should have an opening angle sufficient to give the right spatial resolution with the light source 21, as illustrated in FIG. 10.

The detected signal may be amplified, high pass filtered and amplitude detected before it is fed to an A/D converter 75, as shown in FIG. 9. After digitizing the detected signal, the angle associated with the signal may be calculated for each sensor and position and/or movement may be determined. By transmitting the modulated light in short bursts at a rate of 20-100 Hz depending on needed resolution energy can be saved. The infrared light emitting diode preferably has an opening angle matching the opening angle (e.g., the angle between opposite sides of the cone) of the sensors, which will generally ensure an optimum use of the emitted light, as discussed above.

As stated above, data from the one or more sensors that comprises the movement detection circuitry 20 is coupled to A/D converter 75, as shown in FIG. 9. In the idle mode (e.g., when no object is covering one or more of the sensors), an offset value may be measured from the sensor and output to the A/D converter 75. In order to ensure that an object is detected, as opposed to noise or other spurious signals being detected, a threshold voltage may be applied to one or more data signals output from the A/D converter 75. If values are above a certain threshold value, the measured value may be regarded as being active—(i.e., an object has been detected over one or more sensors).

User movement over the sensors that comprise the movement detection circuitry 20 will generally provide different amplitudes and angles from the object (e.g., a user's hand, a gesture, etc.) to the sensor, which can be calculated, as graphically illustrated in FIG. 12.

An angle between two sensors can be calculated as:

$$α = \frac{a - b}{a + b}$$

where “a” and “b” are the output amplitudes from the sensors respectively. Standard trigonometry calculations may be used to calculate vertical and/or horizontal movement of an object over the sensors.

Another exemplary movement detection circuitry 20 is illustrated in FIGS. 3A and 5. The movement detection circuitry 20 illustrated is in the form of an array of sensors. The movement detection circuitry 20 can determine movement in the X, Y and Z axes based on substantially the same principles as discussed above. For example, as movement is detected, each of the sensors in the array outputs a corresponding value that can be used to allow tracking of the object. Based upon the start location and velocity, acceleration and/or path of the detected movement a corresponding control signal may be generated to control one or more parameters of the electronic equipment and/or applications.

As indicated above, the movement detection circuitry 20 may also be in the form of a camera that comprises one or more image sensors for taking digital pictures and/or movies. Image and/or video files corresponding to the pictures and/or movies may be temporarily and/or permanently stored in memory 54. In some embodiments, the electronic equipment 10 may include a light source 21 that is a standard camera flash that assists the camera take photographs and/or movies in certain illumination conditions.

As stated above, the movement detection circuitry 20 detects movement of an object and generates a corresponding output signal that is converted through A/D converter 75. Generally, the output from the A/D converter 75 corresponds to the vertical distance from the sensor to the object and/or the horizontal position of the object over the sensor. In an idle mode, e.g., when no object is covering the sensor, an offset voltage (e.g., generally not 0 volts) could be measured from the A/D converter 75. To ensure that an object is detected over the one or more sensors, a threshold voltage is applied on the data output from the A/D converter 75, as explained above. If the output values of the sensor are above a certain threshold value, the measured value is regarded as active (e.g., an object is detected over the sensor).

Generally, the output of the movement detection circuitry 20 is provided to the processor 52 (shown in FIG. 9) after being converted from an analog signal to a digital signal by A/D converter 75. The signals are generally indicative of movement and/or location of an object in the target area. The signals may also be indicative of any other desirable parameter (e.g., velocity, acceleration, etc.). The movement detection circuitry 20 may provide separate signals for the location signal for each sensor and/or combine the signals in or more composite signal. Preferably, location and time data is collected in order to determine movement, velocity and/or acceleration of an object (e.g., a user's hand) in the target area.

Referring to FIG. 9, the processor 52 processes the signals received from the movement detection circuitry 20 in any desirable manner. The processor 52 may work in conjunction with the application software 56 and/or other applications and/or memory 54 to provide the functionality described herein.

Aspects of the present invention relate to providing a movement detection algorithm 56 that uses an active state vector to process the signals and or information generated at least in part by the movement detection circuitry 20. A state is generally defined by the current active sensors. A state may also be defined by the duration of time of the current state. For example, if a system has three sensors (e.g., A, B and C), the possible states are: A active; B active; C active; A and B active; A and C active; B and C active; A, B and C active; and none active (NA). A duration parameter (also referred to herein as an “elapsed time” parameter may also be combined with one or more of the possible states. The duration parameter may be used to distinguish between valid states, slow object movement, fast object movements, etc.

For example, referring to FIG. 4, three sensor (e.g., A, B and C) are placed in a triangular configuration. When a vertical movement (e.g. up and down movement) of an object (e.g., a user's hand) over the sensors is to be detected, a problem may occur when the object reaches the B and C sensors. In most instances, one of the B or C sensors will likely be covered before another. The time elapsed condition is introduced to ensure a state sequence of [NA, A active, ABC active, BC active, NA].

The allowed state sequences (also referred to herein as the predefined state sequence) may be any desired sequence of states. Preferably, the allowed states correspond to one or more generally accepted user movements of an object over the movement detection circuitry 20. It is also desirable that the length of the state vectors (e.g., the active state vector, predefined state sequences, allowed state sequences, matching sequence, etc.) be configurable to enhance performance (e.g., by trimming the sequence, inserting additional state sequences, altering the order of the sequences, etc.).

One aspect of the present invention relates to matching and/or filtering the active vector for determining vertical (e.g., up and down) movement and horizontal (e.g., left and right) movement relative to the movement detection circuitry 20. As described below, aspects of the present invention relate to using distinct processing techniques to process horizontal and vertical movement.

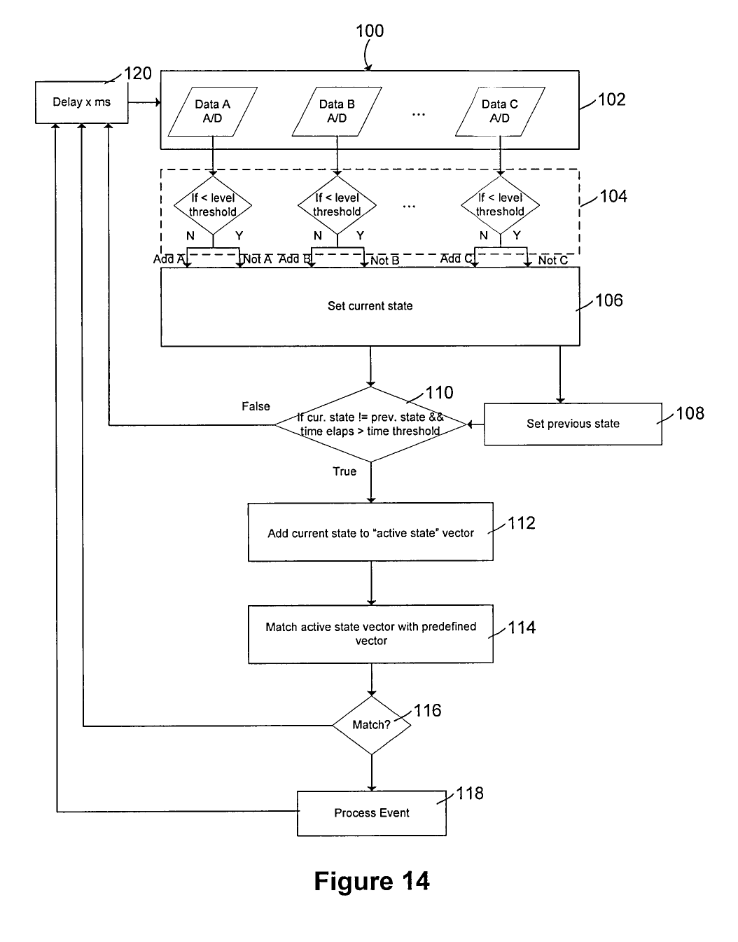

Referring to FIG. 14, an exemplary process 100 to detect horizontal hand movement is illustrated. At block 102, data originating from each of the sensors that comprise the movement detection circuitry 20 is received, converted to a digital signal by A/D converter 75 and measured. The A/D conversion aspects of this step may be omitted if the signal output from sensors is in a suitable digital format.

At block 104, the signals are compared to a threshold value. If the signals have a value less than the threshold value, the sensor is considered to be active and is added to the set current state vector, at block 106. If the signals have a value greater than the threshold value, the sensor is considered to be active and is added to the set current state vector, at block 106. If the signals have a value less than the threshold value, the associated sensor is considered to be inactive and not added to the set current state vector, at block 106. The set current state vector of block 106 is essentially a binary function that includes or excludes a sensor from the current state vector based upon the relative value of the sensor compared to a threshold value. As stated above, the threshold voltage is to distinguish the idle mode from the active mode. The threshold value may be set dynamically, automatically and/or manually.

At block 108, the set previous state is set to the set current state vector of block 106. At block 110, a determination is made as to two conditions. First a determination is made as to whether the current state vector does not equal the previous state vector. If this condition is TRUE, this indicates a change in states of the sensors associated with the movement detection circuitry 20. The second determination is made as to whether the elapsed time is greater than the time threshold. If both conditions are TRUE, at block 112, the current state vector is added to the active state vector. If either of the conditions is FALSE, a delay is implemented at block 120 and the process continues at block 102. As described below, the delay is generally on the order of milliseconds; however, the delay may be shorter or longer based on design considerations and/or user preferences.

At block 114, an attempt is made to match the active state vector with predefined state vectors. At block 116, a determination is made as to whether a match was found. A match generally indicates that the one or more sensors that comprise the movement detection circuitry 20 has output a predefined series of signals that correspond to a predefined movement of an object near the sensors. Accordingly, a block 118, a process that corresponds to the detected event may occur. In one embodiment, one or more parameters associated with the electronic equipment and/or applications executed by the electronic equipment is controlled based at least in part on the detected movement of the object. For example, a control signal may be generated to control an operation and/or function based on the occurrence of the predefined user action. The function performed may be any function capable of being performed by the electronic equipment and/or the software applications executed by the electronic equipment 10. Exemplary use cases include changing the volume output through a speaker and/or ringer; changing a user selectable feature associated with the electronic device; initiating communication tasks; perform various multimedia functions (e.g., play, skip track, rewind, fast forward, etc.), etc. Once the process associated with block 118 occurs and/or is initiated, control of the algorithm is routed to block 120, which constitutes a delay.

If no match is detected at block 116 between active state vector and the predefined state vectors, the active state vector is reset and a delay is implemented at block 120. The delay may be any desired amount of time. Preferably the delay is on the order of milliseconds. However, the delay may be shorter or longer depending on design considerations and/or user preferences. After the delay is processed, the process continues again at block 102. This process continues until the movement detection circuitry 20 is disabled and/or otherwise terminated.

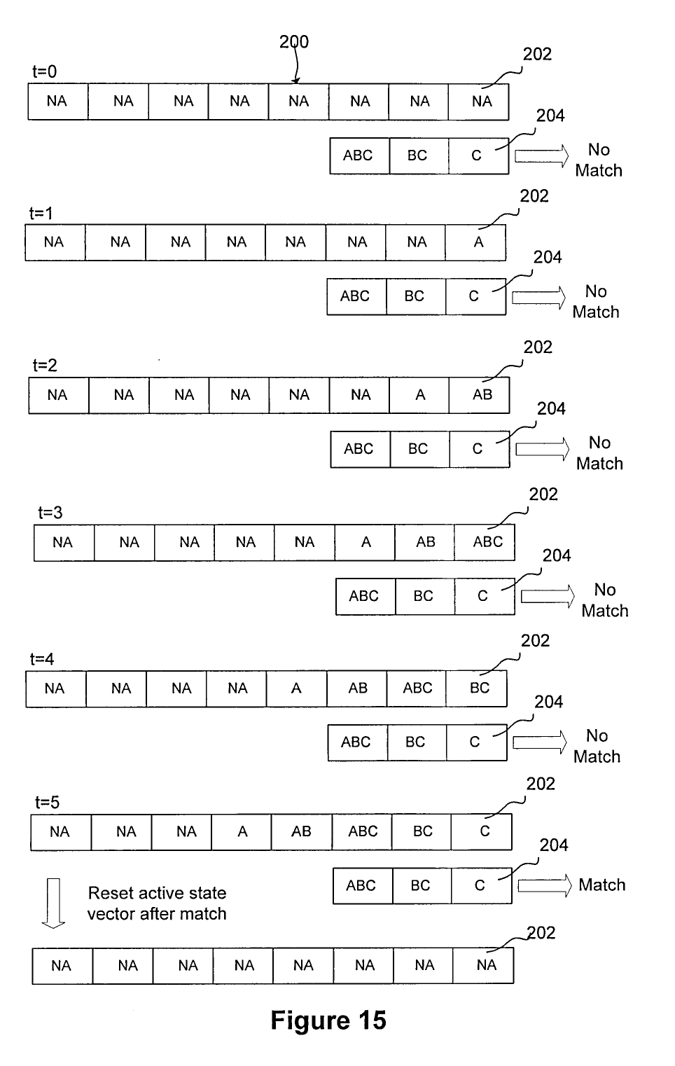

Aspects of the process 100 are illustrated in FIG. 15. Referring to FIG. 15, an active state vector 202 is illustrated at various time points. The illustrated active state vector 202 includes eight separate state variables. One of ordinary skill in the art will readily appreciate that the active state vector 202 may include more or less state variables. A predefined state vector 204 is illustrated. The predefined state vector corresponds to one or more predefined movements to be detected by the movement detection circuitry. As shown in FIG. 15, the predefined state vector includes the states [ABC, BC, C]. Thus, once the listed sequence of state occurs, a match may be detected. As one of ordinary skill in the art will appreciate, there may be a wide variety of predefined movements stored in the state vector, which includes distinct arrangements and various sizes of the state vector corresponding one or more allowed movements.

At time t=0, the active state sensor 202 is [NA, NA, NA, NA, NA, NA, NA, NA], which corresponds to none of the sensors being active for any of the last eight computations (e.g., time periods). The predefined state vector includes [ABC, BC, C]. When the active state vector is compared to the predefined state vector, no match is found.

At time t=1, the active state sensor 202 is [NA, NA, NA, NA, NA, NA, NA, A], which corresponds to only one of the sensors currently being active (e.g., sensor A). The predefined state vector includes [ABC, BC, C]. Again, when the two state vectors are compared, no match is found.

At time t=2, the active state sensor 202 is [NA, NA, NA, NA, NA, NA, A, AB], which corresponds to two of the sensors currently being active (e.g., sensors A and B) and one sensor previously active (e.g., sensor A). The predefined state vector includes [ABC, BC, C]. Again, when the two state vectors are compared, no match is found.

At time t=3, the active state sensor 202 is [NA, NA, NA, NA, NA, A, AB, ABC], which corresponds to three of the sensors currently being active (e.g., sensors A, B and C), two sensors previously active (e.g., sensors A and B), and one sensor being active before the two sensors being active (e.g., sensor A). When the two state vectors are compared, no match is found.

At time t=4, the active state sensor 202 is [NA, NA, NA, NA, A, AB, ABC, BC], which corresponds to two of the sensors currently being active (e.g., sensors B and C) and the previous states being ABC, AB and A. When the active state vector is compared to the predefined state vector, no match is found.

At time t=5, the active state sensor 202 is [NA, NA, NA, A, AB, ABC, BC, C], which corresponds to sensor C currently being active. Since the predefined state vector includes [ABC, BC, C] and the active state sensor includes the sequence [ABC, BC, C], a match is detected. The duration time for the sequence is also calculated and compared. The predefined state sequence has may have two intervals, e.g., 0-300 milliseconds for fast object movements and 300-1000 milliseconds for slow object movements. In the above example, the value to be compared is 50 ms+65 ms+70 ms=185 ms, which corresponds to the detection time associated with detecting each state, as illustrated in FIG. 15. Since the elapsed time for detecting the state is 185 ms, which is less than 300 ms, this movement corresponds to a fast object movement. After the match is detected, a corresponding signal is generated to control one or more parameters associated with the electronic equipment and/or applications executed by the electronic equipment based at least in part on the detected movement of the object. The signal generated may be different based on the time values and/or thresholds.

In addition, the active state sensor is reset to its initial state at t=0, which is [NA, NA, NA, NA, NA, NA, NA, NA] and the process may continue.

Another aspect of the invention relates to detecting vertical movement of an object near the movement detection circuitry 20. Vertical movement is generally processed by receiving data from each of the sensors that comprise the movement detection circuitry 20 and converting the signal to a digital signal by the A/D converter 75. Instead of processing the signals from the A/D converter 75 to be “on” and “off”, as in the horizontal case, the signal level associated each of the signals is processed, as discussed more fully below.

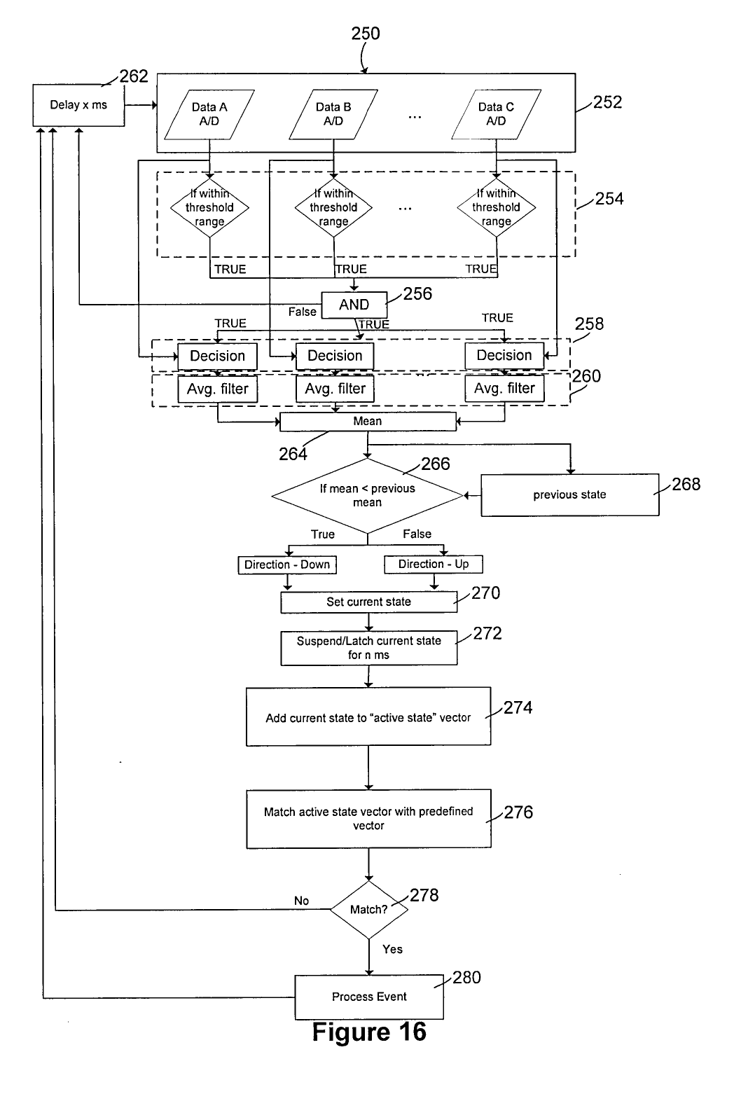

Referring to FIG. 16, a process 250 to detect horizontal hand movement is illustrated. At block 252, data originating from each of the sensors that comprise the movement detection circuitry is received, converted to a digital signal by converter 75 and measured. The conversion aspects of this step may be omitted if the signal output from sensors is in a digital format.

At block 254, the signals may be compared to a low level threshold value and a high level threshold value. At block 256, the signals are coupled to a logic AND gate. If all of the signals are within the range (e.g., the within the range set by low and high level thresholds, the digital signals are routed to an averaging (or smoothing) filter 260. If one or more of the signals are outside of the threshold range, control of the algorithm is delayed at block 262 and then proceeds to block 252 after the delay time elapses.

If each of the signals is within the threshold range, each of the signals is filtered through an average (smooth) filter 260. A moving average filter generally smoothes irregularities and random variations in a data set or signal. This is accomplished by taking a number of readings at various time points and taking the average of the number of readings. For example, if the average filter has a length of three (e.g., three calculations at different time points are averaged), the calculations are as follows:

Input:[x(1),x(2),x(3),x(4),x(5),x(6), . . . ], where x(i) is equal to the output of a sensor at a time period;

Output:[y(1),y(2),y(3),y(4),y(5),y(6), . . . ], where y(i)=

y(1)=(x(1)+x(2)+x(3))/3

y(2)=(x(2)+x(3)+x(4))/3

y(3)=(x(3)+x(4)+x(5))/3

Generally, y(t)=(x(t)+x(t+1)+x(t+2))/k, where k is the length of the filter.

After the signals are processed through the average filter at block 160, a mean value between all of the sensors may be calculated, at block 264, to get a more even and smooth number series, which eliminates disturbance in the input signal.

At block 266, a determination is made as to whether the mean is less than previous mean. If TRUE, the current state vector is defined as DOWN. If the determination is FALSE, the current state vector is defined as UP. At block 168, the mean value is stored. At block 270, the current state vector is set based on the determination made from block 266. At block 272, a latch and/or suspend command is processed to current state for a predetermined time. The latch between the current state vector and the active state vector allows the active state vector to maintain the same states one after the other, which is generally not permitted in the corresponding section of the horizontal movement algorithm.

At block 274, the current state vector is added to the active state vector. At block 276, an attempt is made to match the active state vector with predefined state vectors. At block 278, a determination is made as to whether a match was found. A match generally indicates that the one or more sensors that comprise the movement detection circuitry 20 detected a predefined movement of an object near the sensors. Accordingly, at block 280, a process that corresponds to the detected event may occur. For example, a control signal may be generated to control an operation and/or function based on the occurrence of the predefined user action. The function performed may be any function capable of being performed by the electronic equipment and/or the software applications executed by the electronic equipment 10. Exemplary use cases include changing the volume output through a speaker and/or ringer; changing a user selectable feature associated with the electronic device; initiating communication tasks; perform various multimedia functions (e.g., play, skip track, rewind, fast forward, etc.), etc. Once the process associated with step 180 occurs, control of the algorithm is routed to the delay 262. Once the delay 262 has been processed, the operation continues at block 252 until termination.

If no match is detected at block 278, the active state vector is reset and a delay is implemented at block 262. The delay 262 may be any desired amount of time. Preferably the delay is on the order of milliseconds. However, the delay may be shorter or longer depending on design considerations and/or user preferences. After the delay is processed, the process continues again at block 250. This process continues until the movement detection circuitry 20 is disabled and/or otherwise terminated.

The mean value is generally used to determine the vertical level difference. A difference between the horizontal movement and vertical movement detection processes is that there is a latch between the current state vector and the active state vector. This results in the possibility of providing the active state vector the same states one after another, which is generally not possible in the corresponding process for detecting horizontal hand movement. Another difference between the horizontal movement and vertical movement detection processes is that the matching function for the vertical movement detection does not match against a time duration, as used by the horizontal movement detection process.

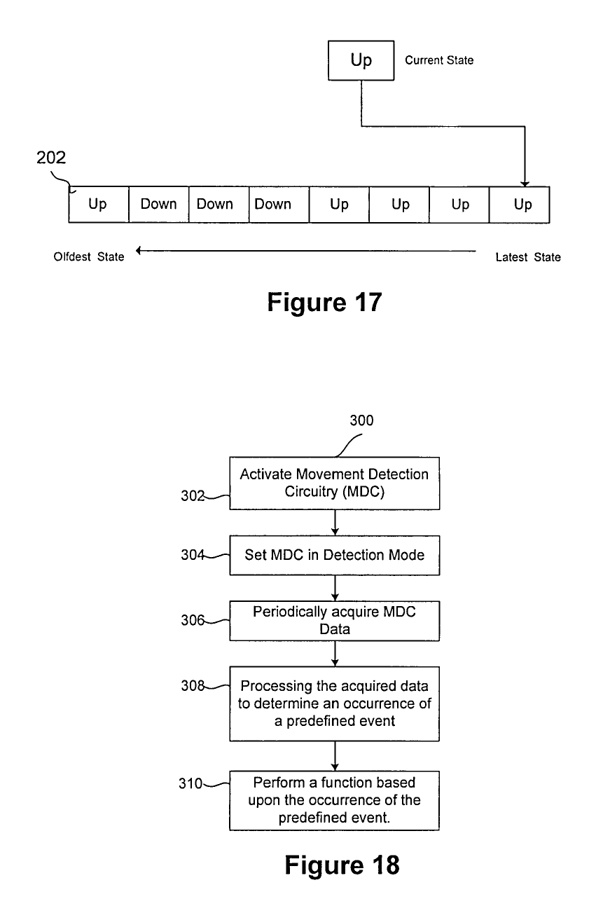

Referring to FIG. 17, an exemplary active state filter 202 is shown for the vertical movement detection algorithm. As shown in FIG. 17, valid states are UP and DOWN. In addition, multiple occurrences of each state may occur over adjacent time periods.

One of ordinary skill in the art will readily appreciate that a wide range of variations may be implemented in the horizontal and/or vertical movement detection algorithms disclosed above, and all such variations shall be included in the scope of the present invention. The horizontal and vertical movement detection algorithms may be performed substantially serially and/or substantially in parallel. In addition, although the figures show a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The object to be measured by the movement detection circuitry 20 may be any suitable object. Suitable objects include, for example, an associated user's hand, one or fingers, multiple hands, a stylus, pointer, a pen, a gaming controller and/or instrument, surface, wall, table, etc. The movement signals (also referred to herein as location signals) may be measured directly and/or indirectly. In one aspect of the present invention, the signals are processed indirectly in order to determine movement information, velocity, and/or acceleration.

The electronic equipment 10 includes a primary control circuit 50 that is configured to carry out overall control of the functions and operations of the electronic equipment 10. The control circuit 50 may include a processing device 52, such as a CPU, microcontroller or microprocessor. The processing device 52 executes code stored in a memory (not shown) within the control circuit 50 and/or in a separate memory, such as memory 54, in order to carry out operation of the electronic equipment 10. The processing device 52 is generally operative to perform all of the functionality disclosed herein.

The memory 54 may be, for example, a buffer, a flash memory, a hard drive, a removable media, a volatile memory and/or a non-volatile memory. In addition, the processing device 52 executes code to carry out various functions of the electronic equipment 10. The memory may include one or more application programs and/or modules 56 to carry out any desirable software and/or hardware operation associated with the electronic equipment 10.

The electronic equipment 10 also includes conventional call circuitry that enables the electronic equipment 10 to establish a call, transmit and/or receive E-mail messages, and/or exchange signals with a called/calling device, typically another mobile telephone or landline telephone. However, the called/calling device need not be another telephone, but may be some other electronic device such as an Internet web server, E-mail server, content providing server, etc. As such, the electronic equipment 10 includes an antenna 58 coupled to a radio circuit 60. The radio circuit 60 includes a radio frequency transmitter and receiver for transmitting and receiving signals via the antenna 58 as is conventional. The electronic equipment 10 generally utilizes the radio circuit 60 and antenna 58 for voice, Internet and/or E-mail communications over a cellular telephone network. The electronic equipment 10 further includes a sound signal processing circuit 62 for processing the audio signal transmitted by/received from the radio circuit 60. Coupled to the sound processing circuit 62 are the speaker 22 and microphone 24 that enable a user to listen and speak via the electronic equipment 10 as is conventional. The radio circuit 60 and sound processing circuit 62 are each coupled to the control circuit 50 so as to carry out overall operation of the electronic equipment 10.

The electronic equipment 10 also includes the aforementioned display 14, keypad 16 and movement detection circuitry 20 coupled to the control circuit 50. The electronic equipment 10 further includes an I/O interface 64. The I/O interface 64 may be in the form of typical mobile telephone I/O interfaces, such as a multi-element connector at the base of the electronic equipment 10. As is typical, the I/O interface 64 may be used to couple the electronic equipment 10 to a battery charger to charge a power supply unit (PSU) 66 within the electronic equipment 10. In addition, or in the alternative, the I/O interface 64 may serve to connect the electronic equipment 10 to a wired personal hands-free adaptor, to a personal computer or other device via a data cable, etc. The electronic equipment 10 may also include a timer 68 for carrying out timing functions. Such functions may include timing the durations of calls, generating the content of time and date stamps, etc.

The electronic equipment 10 may include various built-in accessories, such as a camera 70, which may also be the movement detection circuitry 20, for taking digital pictures. Image files corresponding to the pictures may be stored in the memory 54. In one embodiment, the electronic equipment 10 also may include a position data receiver (not shown), such as a global positioning satellite (GPS) receiver, Galileo satellite system receiver or the like.

In order to establish wireless communication with other locally positioned devices, such as a wireless headset, another mobile telephone, a computer, etc., the electronic equipment 10 may include a local wireless interface adapter 72. The wireless interface adapter 72 may be any adapter operable to facilitate communication between the electronic equipment 10 and an electronic device. For example, the wireless interface adapter 50 may support communications utilizing Bluetooth, 802.11, WLAN, Wifi, WiMax, etc.

With additional reference to FIG. 18, illustrated is a flow chart of logical blocks that make up certain features the movement detection circuitry 20. The flow chart may be thought of as depicting steps of a method 300. Although FIG. 18 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 302 by activating the movement detection circuitry 20. As stated previously, the movement detection circuitry 20 may be in the form of a camera and/or other contactless sensor. Activating the movement detection circuitry 20 may be invoked by any desired manner. For example, the movement detection circuitry 20 may be invoked by user action (e.g., such as by pressing a particular key of the keypad 16, closing a clamshell housing of the electronic equipment 10, receiving an incoming call and/or message, triggering of an alarm, etc.), automatically upon sensing predefined conditions of the electronic equipment, the occurrence of internal events (e.g., an alarm being triggered), the occurrence of an external event (e.g., receiving a call and/or message), and/or any other desired manner or triggering event. One of ordinary skill in the art will readily appreciate that the above list of items is exemplary in nature and there may be a wide variety of parameters and/or conditions that activate the movement detection circuitry 20.

Due to power consumption requirements of the movement detection circuitry 20, it may beneficial to conserve power of the electronic equipment to selectively activate the movement detection circuitry 20. This is especially true when the electronic equipment includes portable communication devices that generally have a limited and/or finite power supply (e.g., a battery). In other situations when the electronic equipment is generally always coupled to a power source, the movement detection circuitry 20 may always be activated, if desired.

When the movement detection circuitry 20 is activated, at step 304, the movement detection circuitry 20 is placed in a data detection mode (e.g., a movement detection mode) for acquiring images and/or sensor data. In the data detection mode, the movement detection circuitry 20 may be activated to detect movement of an object over the one or more sensors that comprise the movement detection circuitry 20. As discussed above, the image detection circuitry 20 allows a user to control the electronic equipment 20 without actually physically touching the electronic equipment 10, by making a user action (e.g., a hand movement, a gesture) in the field of the image detection circuitry 20. Once the user action is detected, the electronic equipment may perform a function based on the detected user action.

At step 306, the movement detection circuitry periodically acquires data points (e.g., images and/or data) at a predefined time periods. The period of time between acquiring images may be any desirable period of time. The period may be selected from predefined periods of time and/or periods of time set by the user. Preferably, less than 1 second elapses between sequential data points. More preferably, about 50 milliseconds elapses between acquiring sequential data points. If too much time elapses, it may be difficult to detect a predefined user action due to velocity in which the object may be moving over the motion detection circuitry. The data may be temporarily stored in memory until a predefined event occurs.

At step 308, the data is generally processed to determine an occurrence of a predefined event. The data is generally processed as discussed above with respect to the horizontal and vertical movement algorithms.

At step 310, regardless of the type of movement detection circuitry 20 used, once the predefined user action is detected by any method, a control signal may be generated to control an operation and/or function based on the occurrence of the predefined user action. The function performed may be any function capable of being performed by the electronic equipment and/or the software applications executed by the electronic equipment 10.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. A method for detecting movement near an electronic device, the method comprising:
providing an electronic device having movement detection circuitry for detecting contactless movement of an object near the electronic device, wherein the device includes a memory for storing one or more predefined state parameters that correspond to one or more predefined movements to be detected by the movement detection circuitry;
detecting movement of an object near the movement detection circuitry;
generating detected state information, wherein the detected state information corresponds at least in part to the detected movement of the object;
comparing the one or more predefined state parameters with the detected state information; and
generating a signal to control one or more user selectable operations of the electronic device based at least in part on the detected movement of the object.

2. The method of claim 1, wherein the movement detection circuitry includes a plurality of detectors.

3. The method of claim 2, wherein the detectors are infrared sensors.

4. The method of claim 2 further including storing the one or more predefined state parameters in a state vector, wherein the predefined state parameters correspond to an output signal associated with at least one of the plurality of detectors.

5. The method of claim 4, wherein the state vector corresponds to one or more desired outputs of each of the plurality of detectors.

6. The method of claim 5 further including iteratively comparing the one or more predefined state parameters to the detected state information to determine if a match exists between the predefined state parameters and the detected state parameters.

7. The method of claim 6, wherein the detected state information is processed in a first manner to determine vertical movement above the plurality of detectors and in a second manner to determine horizontal movement across the plurality of detectors.

8. The method of claim 7, wherein each of the plurality of sensors are processed as either being active or inactive to determine horizontal movement of the object.

9. The method of claim 8, wherein each of the plurality of sensors are averaged to determine vertical movement of the object.

10. The method of claim 5 further including determining an elapsed time associated with detecting the match.

11. The method of claim 10, wherein if the elapsed time is below a threshold time value a first signal is generated and if the elapsed time is above the threshold time value a second signal is generated.

12. The method of claim 1, wherein the one or more user selectable operations consists of at least one selected from the group consisting of: altering audio from a speaker; altering audio output from a ringer or altering audio output from an alarm.

13. An electronic device comprising:
movement detection circuitry configured to detect movement of an object near the movement detection circuitry, wherein the movement detection circuitry includes at least one sensor and generates at least one output signal corresponding to a position of the object detected;
a memory for storing one or more predefined state parameters that correspond to one or more predefined movements to be detected by the movement detection circuitry; and
a processor coupled to the memory and the movement detection circuitry, wherein the processor receives one or more signals from the movement detection circuitry and processes the one or more signals according to a movement detection algorithm to detect the one or more predefined movements to control one more operations of the electronic device.

14. The electronic device of claim 13, wherein the at least one sensor is an image sensor.

15. The electronic device of claim 14, wherein the at least one sensor is a camera.

16. The electronic device of claim 13, wherein the movement detection circuitry includes a plurality of sensors.

17. The electronic device of claim 16, wherein the plurality of sensors are infrared sensors.

18. The electronic device of claim 13, wherein the one or more predefined state parameters are stored in a state vector, wherein the predefined state parameters correspond to an output signal associated with at least one of the plurality of detectors.

19. The electronic device of claim 18, wherein the movement detection algorithm iteratively compares the one or more predefined state parameters to the detected state information to determine if a match exists between the predefined state parameters and the detected state parameters.

20. The electronic device of claim 19, wherein the movement detection algorithm processes detected state information in a first manner to determine vertical movement above the plurality of detectors and in a second manner to determine horizontal movement across the plurality of detectors.

21. The electronic device of claim 20, wherein the plurality of sensors are processed as either being active or inactive to determine horizontal movement of the object.

22. The electronic device of claim 20, wherein the plurality of sensors are averaged to determine vertical movement of the object.

23. The electronic device of claim 20, wherein the movement detection algorithm compares the one or more output signals from the movement detection circuitry at a first time period and the at least one output signal from the movement detection circuitry at a second time period to determine the match.

24. A computer program stored on a machine readable medium in an electronic device, the program being suitable for detecting movement of an object near the electronic device, wherein
when the computer program is loaded in memory of the electronic device and executed, causes one or more predefined state parameters to be stored in memory and movement detection circuitry having a plurality of sensors to generate detected state information associated with movement of the object near the movement detection circuitry and comparing the one or more predefined state parameters with the detected state information, wherein, comparing the one or more predefined state parameters iteratively to the detected state information to determine if a match exists between the predefined state parameters and the detected state parameters, wherein the detected state information is processed by averaging signals received from the plurality of sensors to determine vertical movement above the plurality of detectors and by determining if the signals received from the plurality of sensors are active or inactive to determine horizontal movement across the plurality of detectors; and generating a signal to control one or more user selectable operations of the electronic device based at least in part on the detected movement of the object.
